(19) United States
(12) Patent Application Publication
(10) Pub. No.: US 2022/0409487 A1
(43) Pub. Date: Dec. 29, 2022

(54) Bottle And Bottle Closure Systems

(71) Applicant: MixedIn Pty Ltd, Warriewood (AU)

(72) Inventor: Peter Gillespie, Warriewood (AU)

(73) Assignee: MixedIn Pty Ltd, Warriewood (AU)

(21) Appl. No.: 17/756,341

(22) PCT Filed: Nov. 20, 2020
(86) PCT No.: PCT/AU2020/051252

§ 371 Date: May 23, 2022

(30) Foreign Application Priority Data
Nov. 22, 2019 (AU) 2019904422
Nov. 22, 2019 (AU) 2019904423

(51) Int. Cl. A61J 1/20; B65D 17/42; B65D 81/32; B65D 47/12; A61J 9/00; B65D 17/00; A61J 11/00; A61J 9/08

(52) U.S. Cl. CPC A61J 1/2093; B65D 17/42; B65D 81/3211; B65D 47/122; A61J 9/008; B65D 17/02; A61J 11/008; A61J 9/085

(57) ABSTRACT

A bottle system includes a first housing having a first sealable opening and a distal end, between which a second sealable opening is located, and a first storage chamber being defined between the first and second sealable openings of the first housing. The bottle also includes a second housing having a second storage chamber defined between a third sealable opening and a base, with the first housing and the second housing adapted to be rotatably coupled relative to each other in an end-to-end configuration between at least a first state, in which the first and second storage chambers are separated from each other, and a second state, in which the first and second storage chambers are coterminous. The bottle also includes a cutter such that, in use, the cutter pierces seals of the second and third sealable openings as the first and the second housings are rotatably actuated.

### FIELD OF THE INVENTION

The invention relates to a bottle system and a bottle closure system, kit of parts for bottle and bottle closure systems and their methods of use, and, more specifically, portable bottle and bottle closure systems suitable for the storing and mixing of separately packaged contents prior to consumption.

### BACKGROUND

Conventional premixed bottled beverages or food containing high risk food contents such as dairy substances, probiotics and the like are susceptible to biofouling, have short product shelf lifespans and require access to refrigerated storage. These characteristics do not allow premixed bottled beverages or food, such as an infant formula, to be easily portable for travel, or to be storable for multiple days away from cooling sources without spoilage of content.

While individual components of a given beverage, such as an infant formula, could be obtained separately and combined “on the go”, a user would have to follow a number of time consuming and inconvenient preparation steps, including the steps of: opening a package of infant formula; measuring an appropriate dose of formula powder; obtaining an empty feeding bottle, adding measured formula powder to the feeding bottle; opening a bottle of water; measuring an appropriate volume of water; adding the water to the feeding bottle; mixing the contents inside the bottle for consumption; and packing away unused infant formula and water in separate containers. A typical user in this scenario would not only have to carry more weight during travel to accommodate the packaging of unused ingredients, but exposing the bottle and its ingredients during measuring and mixing steps to the external environment could introduce harmful foreign substances into the drink or food that is being prepared.

The applicant has determined that it would be advantageous to provide a portable mixable bottle system or a bottle closure with improved convenience and efficacy. The present invention, in its preferred embodiments, seeks to at least in part alleviate the above-identified problems.

### SUMMARY OF THE INVENTION

According to a first aspect of the present invention, there is provided a bottle system, comprising a first housing having a proximal end, at which a first sealable opening is located, and an opposing distal end, between which a second sealable opening is located, wherein a first storage chamber is defined between the first and second sealable openings of the first housing; a second housing having a second storage chamber defined between a third sealable opening and a base, wherein the first housing and the second housing are adapted to be rotatably coupled relative to each other in an end to end configuration between at least a first state, in which the first and second storage chambers are separated from each other, and a second state, in which the first and second storage chambers are coterminous; and a cutter mounted within either the first storage chamber or the second storage chamber such that, in use, the cutter pierces seals of the second and third sealable openings, thereby combining contents of the first and second storage chambers, as the first and the second housings are rotatably actuated from the first state to the second state.

Preferably, the first housing comprises an overmoulded skirt configured to rotatably engage with a threaded portion of the second housing.

Preferably, the overmoulded skirt is located at or about the distal end of the first housing.

Preferably, the overmoulded skirt partially overlaps an external surface of the second housing.

Alternatively, the second housing comprises an overmoulded skirt configured to rotatably engage with a threaded portion of the first housing.

Preferably, the first housing comprises a first annular shoulder located at or adjacent the second sealable opening and the second housing comprises a second annular shoulder located at or adjacent the third sealable opening, and wherein the first and the second shoulders are arranged to abut each other when the first and second housings are rotatably coupled in a third state, in which the housings are restrained from further rotation relative to each other in the direction of relative rotation.

Preferably, the cutter comprises a cutting edge oriented in the direction of the seal such that relative rotation of the first and second housings from the first state to the second state causes the cutter to cut the seals along a circular path.

Preferably, the cutter comprises a concentric rim and the cutting edge extends from a perimeter of the concentric rim.

Preferably, the cutting edge is integrally formed with the concentric rim, and wherein the cutting edge conforms to a contour of the concentric rim.

Preferably, the concentric rim has a diameter that is smaller than that of the second or third sealable openings. Preferably, the concentric rim has a diameter of about 30 to 40 millimetres.

Preferably, the cutter further comprises an annular frame, which is configured to be mountable within the first or second storage chamber to secure placement of the cutter.

Preferably, the cutting edge of the cutter is joined to the annular frame by one or more supporting struts.

Preferably, the cutting edge of the cutter is located adjacent the seals.

Preferably, in use, the first storage chamber is configured to store dry content and the second storage chamber is configured to store liquid content.

Alternatively, in use, the first storage chamber is configured to store liquid content and the second storage chamber is configured to store dry content.

Preferably, the seals comprise aluminium or composite foil seals attached to a rim surface of the respective sealable opening.

Preferably, the bottle system further comprises a bottle closure mountable to the proximal end of the first housing.

Preferably, the bottle closure comprises a dispenser for dispensing content from the first sealable opening.

Preferably, the bottle system further comprises a carriage member mountable to a neck portion located adjacent the sealable opening of the first housing, the carriage member comprising an annular flange within which an internal cavity is defined; a cutter attachable to the carriage member such that the cutter is movable with, and located substantially within the internal cavity of, the carriage member, the cutter being configured to pierce a seal of the first sealable opening, and wherein the carriage member and the neck are configured to be frictionally interengageable in use between an extended state, whereby the cutter does not pierce the seal, and a retracted state, whereby the cutter is able to pierce the seal upon relative rotation of the carriage member and the neck.

According to a second aspect of the present invention, there is provided a method of operating a bottle system according to any one of the preceding claims, the method comprising rotatably coupling the first housing and the second housing in an end to end configuration from the first state to the second state such that the cutter pierces seals of the first storage chamber and the second storage chamber to combine contents stored therein. Preferably, the combined contents are mixed by agitation of the bottle system, when the first and second housings are in a coupled state, and dispensed through the first sealable opening of the first housing.

According to a third aspect of the present invention, there is provided a kit of parts for a bottle system comprising a first housing, a second housing, and a cutter mountable within either a first storage chamber or a second storage chamber all as previously described.

According to a fourth aspect of the present invention, there is provided a bottle closure system, comprising a housing having a sealable opening and a neck located adjacent the sealable opening, a carriage member mountable to the housing, the carriage member comprising an annular flange within which an internal cavity is defined; and a cutter attachable to the carriage member such that the cutter is movable with, and located substantially within the internal cavity of, the carriage member, the cutter being configured to pierce a seal of the sealable opening during use, wherein the carriage member and the neck are configured to be frictionally interengageable in use between an extended state, whereby the cutter does not pierce the seal, and a retracted state, whereby the cutter is able to pierce the seal upon relative rotation of the carriage member and the neck.

Preferably, the neck comprises a substantially annular rib and the flange comprises a corresponding projection configured for frictional engagement with the rib.

Alternatively, the neck comprises a rib extending at least partially along a perimeter of the neck and the flange comprises a substantially annular projection configured for frictional engagement with the rib.

Preferably, the neck and the flange comprise corresponding threadable portions such that relative rotation of the neck and the flange during threadable engagement in the retracted state causes the cutter to progressively pierce the seal.

Preferably, the threadable portion of the neck is located on an external surface of the neck between the sealable opening and the rib.

Preferably, the neck comprises a further rib located adjacent the rib to inhibit rotational movement of the carriage member relative to the neck when the corresponding projection of the flange abuts the further rib in the retracted state, thereby locking relative movement of the neck and the flange in the rotational direction of travel.

Preferably, the further rib is located about 6 to 10 millimetres below the rib.

Preferably, the carriage member comprises a top opening configured for operatively receiving the cutter.

Preferably, the top opening is configured for receiving a nozzle or a teat in combination with the cutter.

Preferably, a length of the nozzle or teat is configured to be foldably stowable relative to a longitudinal body of the nozzle or teat.

Preferably, the nozzle or teat comprises an annular groove configured for frictionally engaging a corresponding rim of the top opening of the carriage member.

Preferably, the cutter comprises a neck portion which is frictionally engageable with a corresponding internal cavity rim of the nozzle or teat so that the cutter is operatively coupled with the nozzle or teat in use.

Preferably, the cutter comprises a cutting edge oriented in the direction of the seal such that relative rotation of the neck and the flange in the retracted state causes the cutter to cut the seal along a circular path.

Preferably, the cutter comprises a concentric rim and the cutting edge extends from a perimeter of the concentric rim.

Preferably, the cutting edge is integrally formed with the concentric rim, and wherein the cutting edge conforms to a contour of the concentric rim.

Preferably, the concentric rim has a diameter that is larger than that of the top opening of the carriage member.

Preferably, the concentric rim has a diameter of about 25 to 35 millimetres.

Preferably, the closure system further comprises a filter located proximate the sealable opening so as to filter contents to be dispensed from the housing during use, the filter being attachable to the carriage member.

Preferably, the filter is associated with the cutter. Alternatively, the filter is integrally formed with the cutter. Alternatively, the filter comprises a membrane filter.

Preferably, the closure system further comprises a guide member for displacing the seal after the seal is pierced by the cutter in the retracted state, the guide member is operatively coupled to the carriage member.

Preferably, the guide member is a vertically oriented pin integrally formed with the filter.

Preferably, the seal comprises an aluminium foil seal attached to a rim surface of the sealable opening.

Preferably, the closure system further comprises a dome shaped cap.

According to a fifth aspect of the present invention, there is provided a method of operating a bottle closure system according to any one of the preceding claims, the method comprising rotating the carriage member relative to the neck of the housing together in an end to end configuration from the extended position to the retracted position, and rotating the carriage member relative to the neck so as to progressively pierce the seal, thereby allowing access to any contents stored therein.

According to a sixth aspect of the present invention, there is provided a kit of parts for a bottle closure system comprising a housing, a carriage member and a cutter associated with the carriage member all as previously described.

According to a seventh aspect of the present invention, there is provided a bottle system having a bottle closure system as previously described, in which the housing comprises a proximal end, at which the sealable opening is located, and an opposing distal end, between which a second sealable opening is located, wherein a first storage chamber is defined between the first and second sealable openings of the first housing; the bottle system further comprises a second housing having a second storage chamber defined between a third sealable opening and a base, wherein the first housing and the second housing are adapted to be rotatably coupled relative to each other in an end to end configuration between at least a first state, in which the first and second storage chambers are separated from each other, and a second state, in which the first and second storage chambers are coterminous; and a second cutter mounted within either the first storage chamber or the second storage chamber such that, in use, the second cutter pierces seals of the second and third sealable openings, thereby combining contents of the first and second storage chambers, as the first and the second housings are rotatably actuated from the first state to the second state.

Further aspects of the present invention and further embodiments of the aspects described in the preceding paragraphs will become apparent from the following description.

While aspects of the invention will be described below for use in combination with each other in the preferred embodiments of the present invention, it is to be understood by a skilled person that some aspects of the present invention are equally suitable for use as standalone inventions that can be individually incorporated into uses not described herein.

### BRIEF DESCRIPTION OF THE DRAWINGS

The invention will now be described, by way of non-limiting example only, with reference to the accompanying drawings, in which:

FIG. 1 is a perspective view from above of a bottle system according to a preferred embodiment of the present invention;

FIG. 2 is a transparent perspective view from above of the bottle system as shown in FIG. 1;

FIG. 3 is an orthogonal front view of the bottle system as shown in FIG. 1;

FIG. 4 is a perspective view from above of a second housing of the bottle system according to a preferred embodiment of the present invention;

FIG. 5 is a front view of the second housing of the bottle system according to an embodiment as shown in FIG. 5;

FIG. 6A is a perspective view from above of a first housing of the bottle system according to a preferred embodiment of the present invention;

FIG. 6B is a transparent perspective view from above of the first housing of the bottle system according to an embodiment as shown in FIG. 6A;

FIG. 6C is a partial sectional view of the first housing of the bottle system showing an internally seated cutter according to a preferred embodiment of the present invention;

FIG. 7 is a transparent front view of the first housing of the bottle system according to an embodiment as shown in FIG. 6B;

FIG. 8A is a perspective view from above of a cutter of the bottle system according to a preferred embodiment of the present invention;

FIG. 8B is a front view of the cutter of the bottle system according to an embodiment as shown in FIG. 8A;

FIG. 9A is a perspective view from above of a carriage member of the bottle system according to a preferred embodiment of the present invention;

FIG. 9B is a perspective view from below of the cutter of the bottle system according to an embodiment as shown in FIG. 9A;

FIG. 10A is a perspective view from above of a further cutter and filter assembly of the bottle system according to a preferred embodiment of the present invention;

FIG. 10B is a perspective view from below of the further cutter and filter assembly of the bottle system according to an embodiment as shown in FIG. 10A;

FIG. 11A is a perspective view from above of a stowable teat of the bottle system according to a preferred embodiment of the present invention;

FIG. 11B is a perspective view from below of the stowable teat of the bottle system according to an embodiment as shown in FIG. 11A;

FIG. 12A is a perspective view from above of a cap of the bottle system according to a preferred embodiment of the present invention;

FIG. 12B is a perspective view from below of the cap of the bottle system according to an embodiment as shown in FIG. 12A;

FIG. 13 is a transparent perspective partial sectional view of the bottle system showing relative locations of the bottle housings and the cutter according to the preferred embodiment of the present invention;

FIG. 14 is a perspective view from above of the bottle system showing relative locations of the bottle housings and the cutter according to the preferred embodiment of the present invention;

FIG. 15A is a perspective view of a closure assembly of the bottle system showing an assembled form of a carriage member, a cutter and a teat all according to a preferred embodiment of the present invention;

FIG. 15B is a perspective view from below of the closure assembly of the bottle system showing an assembled form of a carriage member, a cutter and a filter according to an embodiment as shown in FIG. 15A;

FIG. 16 is a perspective view from below of a first housing of the bottle system showing the location of a seated cutter according to a preferred embodiment of the present invention; and

FIG. 17 is a perspective view of an assembly of a teat and cutter of the bottle system according to a preferred embodiment of the present invention.

In the description and drawings of this embodiment, the same reference numerals are used as have been used in respect of the first embodiment, to denote and refer to corresponding features.

### DETAILED DESCRIPTION OF THE EMBODIMENTS

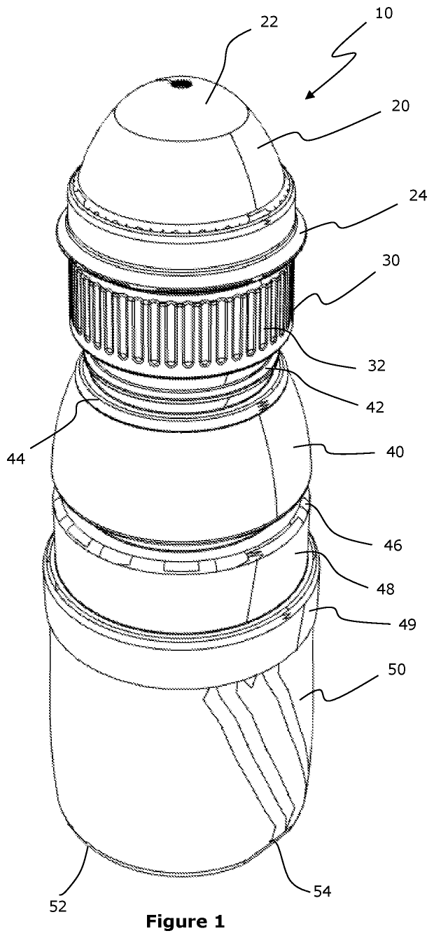

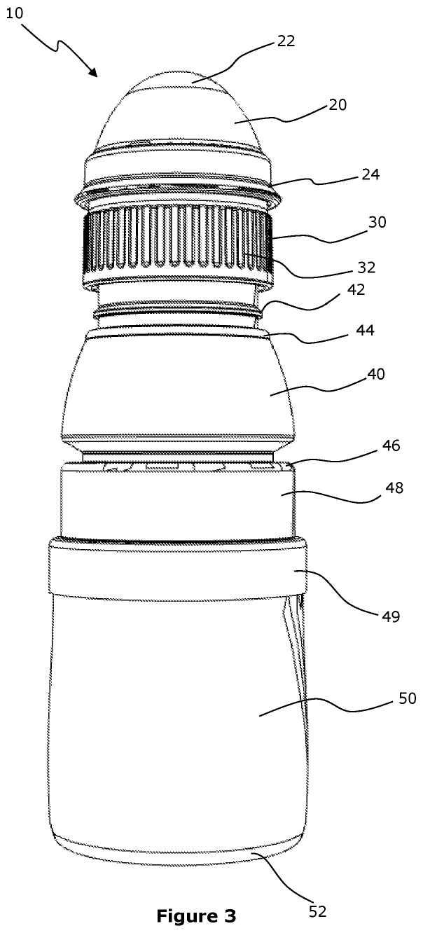

FIGS. 1 to 3 show an assembled bottle system 10 according to a preferred embodiment of the present invention. The bottle system 10 comprises a number of combinable sections capable of sealingly storing contents as well as mechanisms for conveniently coupling, opening and mixing stored contents during use. In particular, the bottle system 10 comprises a first housing 40, which contains a first storage chamber 410, and a second housing 50, which contains a second storage chamber 510, and the first and second housings 40, 50 are configured to be coupled in an end to end configuration. The bottle system 10 also provides, in one embodiment, a closure system having a carriage member 30 that is engageable with a proximal end of the first housing 40. The carriage member 30 is adapted to host a cutting mechanism, a nozzle or teat 60, and a cap 20. A bottle system 10 embodying the present invention will now be described in detail.

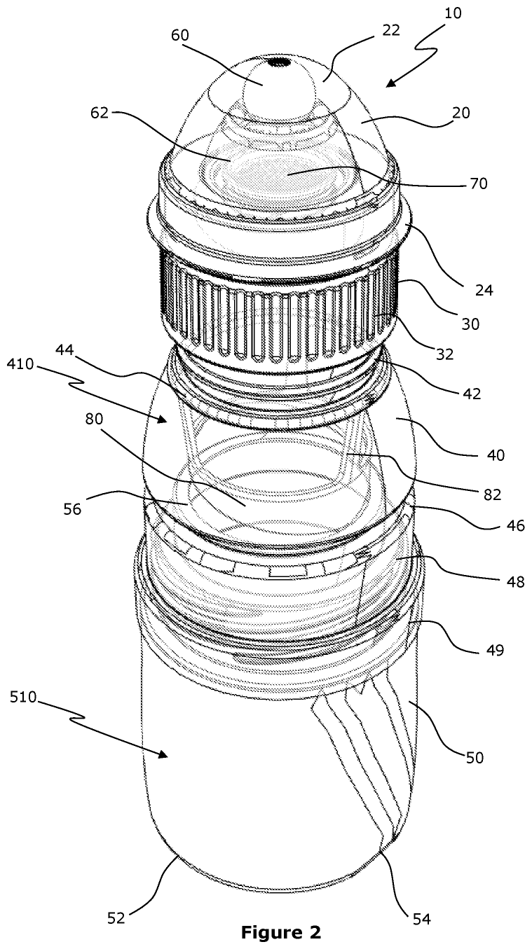

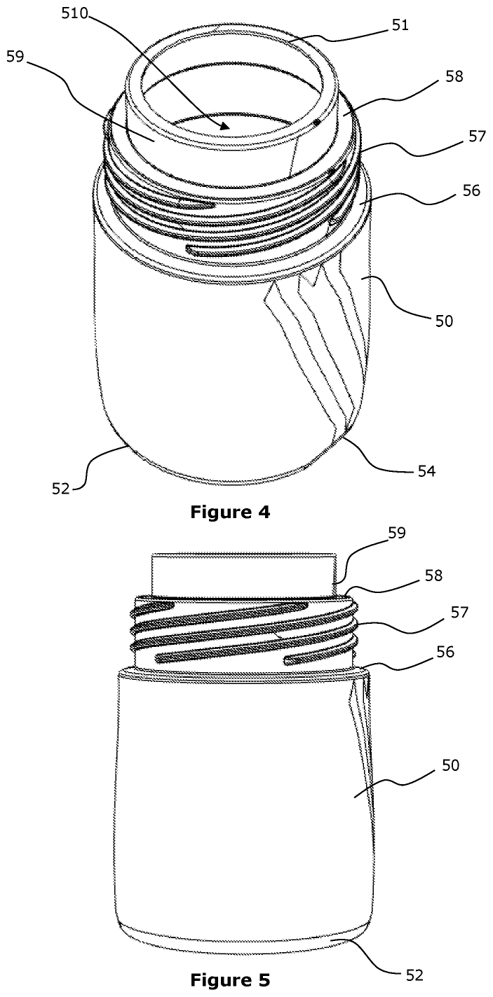

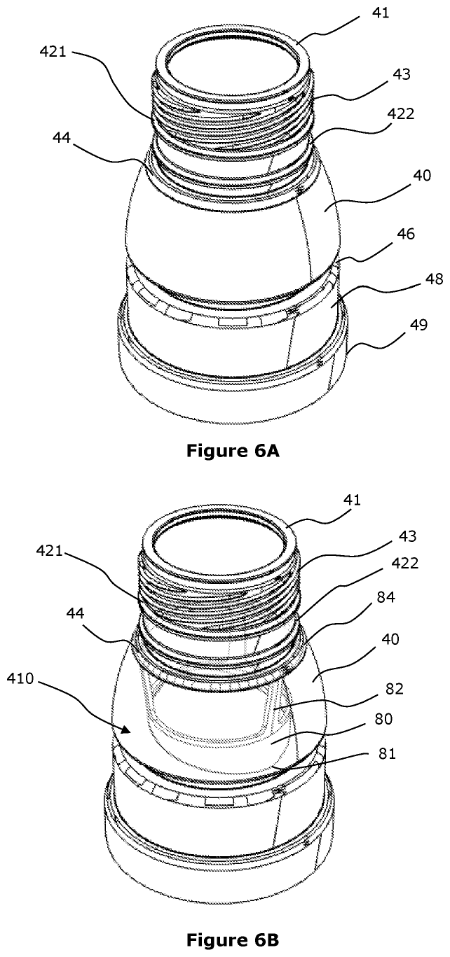

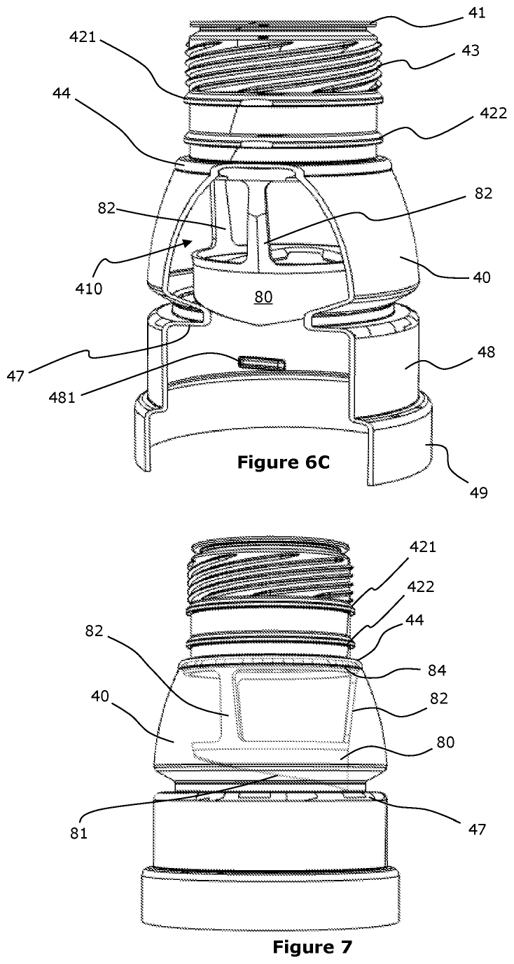

With reference to FIGS. 2, and 6A to 6C, the first housing 40 comprises an annual wall having a proximal end, which is the general end region of the first housing 40 that is closer to the nozzle or teat 60 of the bottle 10 when it is in an assembled state, and an opposing distal end. A first sealable opening 41 is located at the proximal end, the first sealable opening 41 serves as an outlet from the first housing 40 and could be sealed in any suitable manner, for example by way of a hermetic aluminium foil seal, to prevent air or liquid ingress past the seal. A second sealable opening 47 is located within the first housing 40, beneath the first sealable opening 41, but not necessarily located at the distal end. Likewise, the second sealable opening 47 could be sealed in any suitable manner. The first storage chamber 410 is defined between the first and second sealable openings 41, 47 of the first housing 40, when the sealable openings 41, 47 are sealed.

In accordance with the preferred embodiment, the first housing 40 is provided with a neck 43 located adjacent the first sealable opening 41. In one embodiment, the neck 43 is provided with a threadable portion for coupling with a corresponding threadable portion of the carriage member 30. The neck 43 comprises a substantially annular rib 421 at the end of the threadable portion of the carriage member 30 and a further substantially annular rib 422 below the rib 421 for frictional engagement with a corresponding projection 36 of the carriage member 30. In alternative configurations, the neck 43 instead comprises a rib 421 which extends at the least partially along perimeter of the neck 43, and the rib 421 is likewise configured for frictional engagement with the corresponding projection 36 of the carriage member 30. In some embodiments, the threadable portions are provided with multi-thread configurations so as to increase rotational torque power of the engagement between the carriage member 30 and the neck 43. Details of a compatible bottle closure system will be discussed in a later section.

The first housing 40 is further provided with overmoulded skirt sections 48, 49 which, in use, overlap an external surface of the second housing 50. The overmoulded skirt sections 48, 49 are provided with threadable portions 481 for interfacing with a corresponding threadable portion 57 of the second housing 50. It is to be appreciated that although the overmoulded skirt sections 48, 49 are shown to be integrally formed with the first housing 40 at or about the distal end, it is possible that in alternative configurations, the overmoulded skirt sections 48, 49 could be located instead on the second housing 50 and overlap an external surface of the first housing 40 as well as being threadably engageable with the first housing 40. The overmoulded skirt sections 48, 49 provide a mechanism for operatively coupling the first and second housings 40, 50, though it is to be understood that other coupling mechanisms may also be suitable. It is also to be understood that it is not required for both overmoulded skirt sections 48, 49 to be present to secure the first and second housings 40, 50, and it is possible to have just one overmoulded skirt section.

Turning now to FIGS. 4 and 5, the second housing 50 is in the form of a vessel having a third sealable opening 51 and a base 52. The base 52 may be configured with one or more chamfer edges 54. A second storage chamber 510 is defined in the second housing 50 between the third sealable opening 51 and the base 52. The second housing, in one configuration, is provided with a threadable portion 57 for rotationally engaging and coupling with the first housing 40 in an end to end configuration. In one instance, the threadable portion 57 of the second housing is configured to interface with a corresponding threadable portion of the overmoulded skirt section 48 of the first housing 40. In the preferred embodiment, the second housing 50 is provided with rim portions 56, 58 which are adapted to engage and abut, respectively, the second sealable opening 47 and an internal rim 45 of the overmoulded skirt sections 48, 49 of the first housing 40. The third sealable opening 51 can be sealed in any suitable manner such as the use of hermetic foil sealing.

The first housing 40 and the second housing 50 are so configured, for example with the overmoulded skirt sections 48, 49, to be rotatably coupled relative to each other in an end to end configuration bringing together the first and second storage chambers 410, 510, which in effect means that rotational coupling of the housings 40, 50 brings the second sealable opening 47 closer to the third sealable opening 51. Specifically, the first and second housings 40, 50 are configured to be coupled relative to each other between a first state, in which the first and second storage chambers 410, 510 are separated from each other, and a second state, in which the first and second storage chambers 410, 510 become coterminous. By coterminous, it is meant that the third sealable opening 51 of the second storage chamber 510 moves to join with the first storage chamber 410 such that the boundaries of the first and second storage chambers 410, 510 overlap one another. In this condition, the contents of the respective storage chambers are free to be combined.

In the first state, the first and second housings 40, 50 may be separated, or rotatably coupled, but the first and second storage chambers 410, 510 are not yet in contact. In the second state, the first and second housings 40, 50 are rotatably coupled and that the respective boundaries of the first and second storage chambers 410, 510 are commingled by the third sealable opening 51 passing through the second sealable opening 47 thereby entering the boundaries of the first storage chamber 410. During use, the seal of the second storage chamber 510 is pushed up against the seal sealing the second sealable opening 47 and eventually pushes through the second sealable opening 47 in the second state. In an alternative embodiment, the housings 40, 50 are so configured so that the second state is instead achieved by the second sealable opening 47 passing through the third sealable opening 51 and entering the boundaries of the second storage chamber 510.

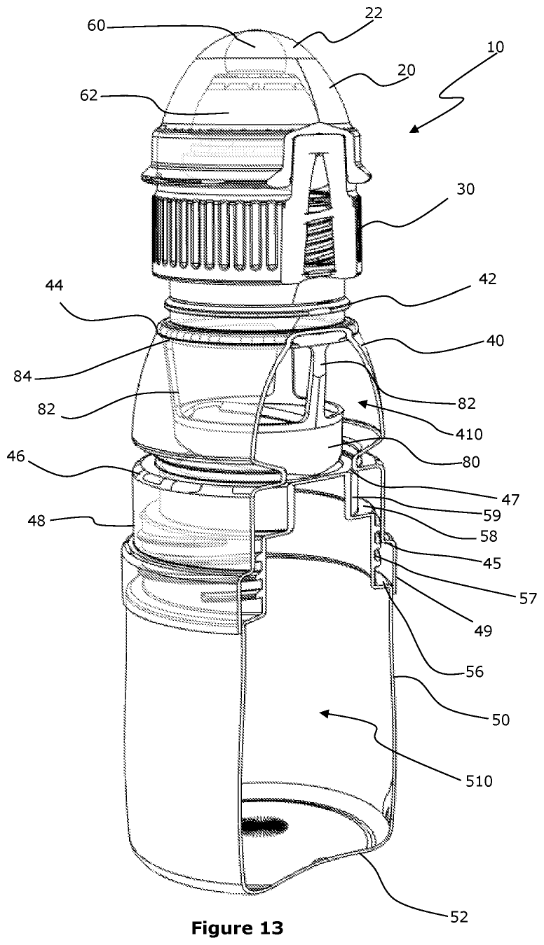

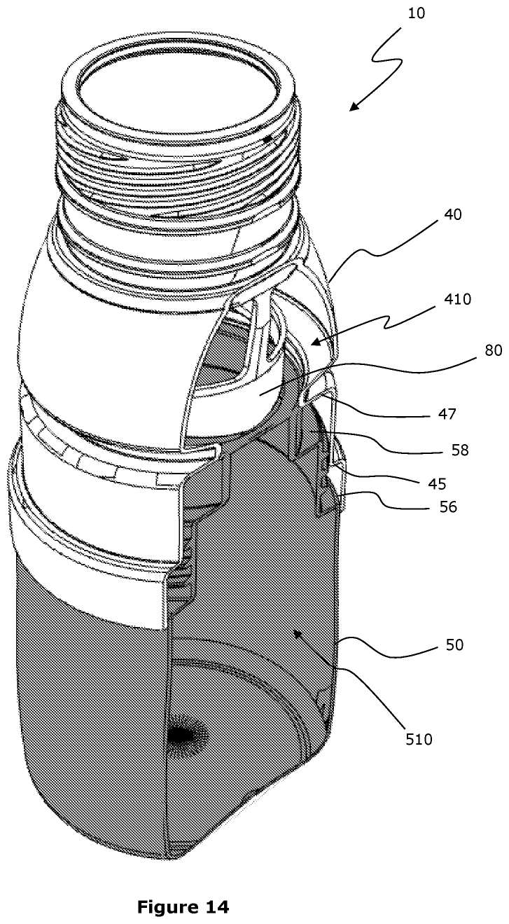

With reference to FIGS. 13 and 14, and according to the preferred embodiment, the second housing 50 comprises an annular shoulder 58 which corresponds to an internal annular shoulder associated with the second sealable opening 47. When the first housing 40 and the second housing 50 are rotatably coupled together as previously described from the first state to the second state, the annual shoulder 58 of the second housing 50 will come into contact with the annular shoulder of the second sealable opening 47 so as to restrict further rotation of the first and second housings 40, 50 in the direction of relative rotation—this condition, whereby the first and second housings 40, 50 are effectively locked together in the direction of rotation, denotes a “third state” between the housings 40, 50. In one embodiment, the second housing 50 comprises a second annular shoulder 56 that is adapted to engage a corresponding internal annular shoulder 45 of overmoulded skirt section 49. The engagement of this second set of shoulders further restricts rotational movement between the first and second housings 40, 50. It is also to be appreciated that, in the preferred embodiment, the coupling of the first and second housings 40, 50 in the third state results in a sealed engagement between either or both of the over moulded skirt sections 48, 49 of the first housing 40 and an external surface of the second housing 50 so as to prevent leakage of any mixed contents within the assembled housings 40, 50.

The bottle system 10 is also provided with a cutter 80 which could be mounted within either the first storage chamber 410 or the second storage chamber 510 for the purpose of cutting through seals (not shown) sealing the contents of the respective sealable openings 47, 51 of the first and second storage chambers 410, 510. In the preferred embodiment, the cutter 80 is mounted within the first storage chamber 410 so that when the first and second housings 40, 50 are coupled relative to each other from the first state to the second state during use, the cutter 80 pierces through both seals sealing the second and third sealable openings 47, 51, thereby allowing contents of the first and second storage chambers 410, 510 to be combined. In an alternative embodiment, the cutter 80 is located within the second storage chamber 510 and configured to pierce through both seals as the first and second housings 40, 50 are rotatably coupled from the first state to the second state during use. The cutter 80 will now be described for the preferred embodiment in which the cutter 80 is located within the first storage chamber 410; however, it is to be understood that it is equally suitable for the cutter 80 to be configured such that it operates from the second storage chamber without departing from the spirit of the invention.

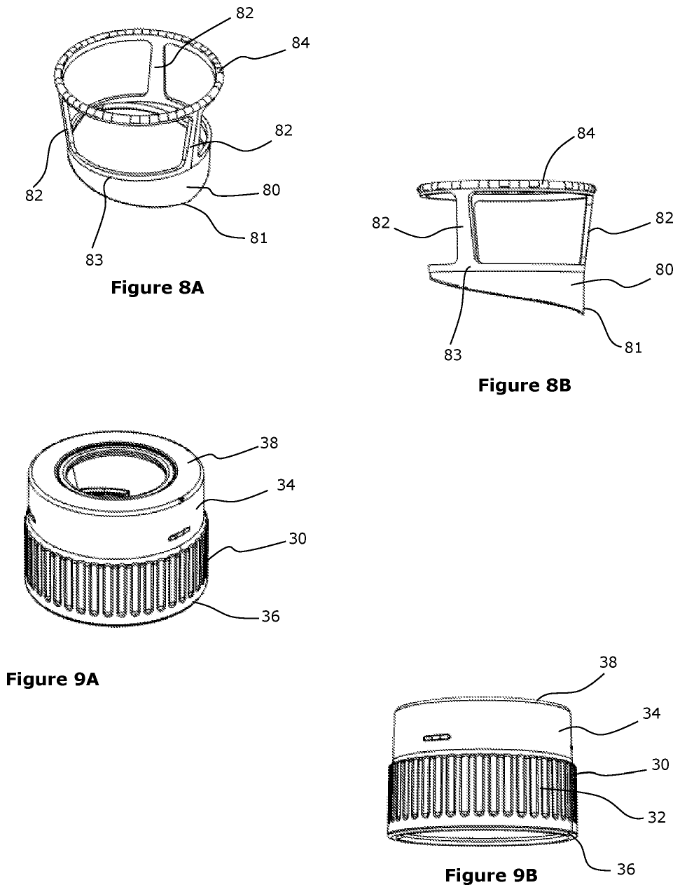

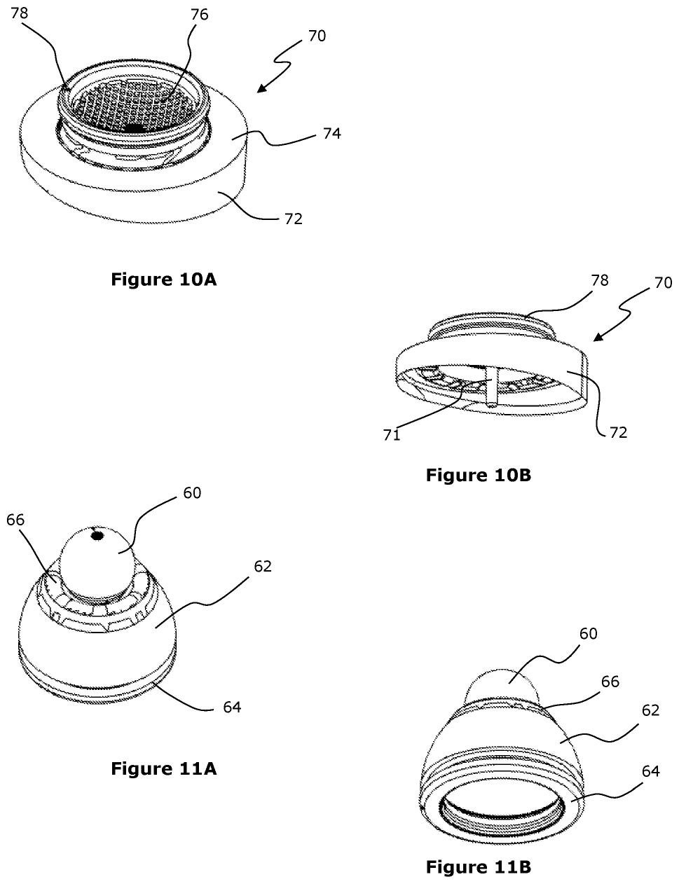

With reference to FIGS. 8A and 8B, the cutter 80 comprises a cutting edge 81 mounted to a concentric rim 83. The cutting edge 81 is configured to orient or point in the direction of the seal in use and the cutting edge 81 extends from, and is located on an off-centre side of the concentric rim 83 so that relative rotation of the first and second housings 40, 50 from the first state to the second and third states (and by extension, relative rotation of the cutting edge 81) causes the cutting edge 81 to cut the seals sealing the respective first and second storage chambers 410, 510 along a circular path. In one embodiment, the cutting edge 81 extends in the direction of the seal from a perimeter of the concentric rim 83. In the preferred embodiment, the cutting edge 81 is integrally formed with the concentric rim 83 and substantially conforms to a contour of the rim 83. It would be appreciated that the cutting edge 81 of the cutter 80 is configured to operate within the diameter of the second or third sealable openings 47, 51 so as to pierce and cut the respective seals in use. In some configurations, the concentric rim 83 has a diameter that is smaller than that of the second or third sealable openings 47, 51 and non-limiting dimensional examples of the concentric rim 83 include diameter of about 30 to 40 millimetres. While the cutting edge 81 has been described to be mounted to a concentric rim 83, it is to be understood that other suitable cutter and cutting edge configurations may be used, such as a single cutter downwardly pointing blade mounted off-centre relative to the sealable openings 47, 51 of the first and second storage chamber 410, 510.

The cutter 80 can be mounted within either the first or second storage chamber 410, 510 by any suitable configuration. In one example, the cutter 80 is provided with an annular frame 84 which is dimensioned to be frictionally engageable with an internal recess or groove 44 of the first storage chamber 410 so as to be securely seated within the chamber 410. The concentric rim 83 and cutting edge 81 of the cutter 80 are joined to the annular frame 84 by one or more supporting struts 82, forming an assembly of the cutter 80. The cutter assembly is so arranged within the storage chamber 410 that the cutting edge 81 is located adjacent the seal of the second sealable opening 47. In the preferred embodiment, the assembly of the cutter 80 is formed as an integral piece.

In use, the first storage chamber 410 can be used to store dry content and the second storage chamber 510 can be used to store liquid content, and the coupling of the two chambers 410, 510 as described previously allows the mixing of contents stored in both chambers 410, 510. Alternatively, it is to be appreciated that it would be equally suitable for the first storage chamber 410 to store liquid content and for the second storage chamber 510 to store dry content. It is also to be understood that the relative dimensions of the storage chambers 410, 510 can be adjusted for functional purposes without departing from the scope of the invention.

Although aluminium foil seals have been described as suitable for use in sealing the various sealable openings 41, 47, 51 of the first and second storage chambers 410, 520, it is to be appreciated that seals made from other materials such as paper, plastic, composite or any other metallic foils may also be used. The seals may also be secured to the various sealable openings 41, 47, 51 of the bottle system 10 by way of any suitable methods known in the art, including chemical adhesion, thermal sealing and mechanical fastening.

In use, contents are advantageously packaged and stored separately in the first and second storage chambers 410, 510 of the respective first and second housings 40, 50 so as to maximise their shelf life and prevent premature spoilage of the mixable content. The first and second housings 40, 50 may be loosely coupled in an end to end configuration in the first state. When a user is ready to mix the contents contained within the two storage chambers 410, 510, the user would rotate the first and second housings 40, 50 relative to each other toward the second state, during which the seals of the second and third sealable openings 47, 51 will be pierced by the cutter 80, thereby allowing some of the contents to mix. Continued rotational movement of the first and second housings 40, 50 toward the third state, in which the housings 40, 50 are locked in the direction of rotation relative to each other, causes the cutter 80 progressively cut the seals along a circular path. It is to be appreciated that at the same time the third sealable opening 51 is pushed into the second sealable opening 47 and asserts a force on the seals sealing the respective sealable openings 47, 51 to keep the seals open. Contents from the first storage chamber 410 would fall into the second storage chamber 510 and could be further mixed by agitating or shaking the combined housings 40, 50 in the third state. Mixed content from the combined housings 40, 50 could be dispensed from the first sealable opening 41, for example, by removing or cutting open the seal of the first sealable opening 41. The sealable opening 41 is attachable to a suitable dispenser or outlet.

Features described above in respect of the first and second housings 40, 50 of the bottle system 10 could be fitted to a compatible bottle closure system as will be described below. In other embodiments, the proximal end of the first housing 40 is adapted to be compatible with conventional bottle closures and/or dispensers as outlet for dispensing mixed contents of the assembled bottled system 10.

With reference to FIGS. 6, 13 and 15, the bottle system is further provided with a compatible bottle closure system. In the preferred embodiment of the closure system the first housing 40 comprises a neck 43 located adjacent the first sealing opening 41 and a carriage member 30 is configured with an annular flange 32, which defines an internal cavity of the carriage member 30, so as to be mountable to the neck 43 of the first housing 40. In one configuration, the neck 43 and the flange 32 of carriage member 30 are provided with corresponding threadable portions to enable rotational engagement and coupling of the neck 43 and the carriage member 30.

The carriage member 30 provides a number of functions, including attaching a suitable outlet or dispenser to the first housing 40 (or the combined housings 40, 50), piercing a seal of the first sealable opening 41, holding a bottle cap 20 and filtering contents contained within the first housing 40. The carriage member 30 comprises a top opening adjacent a top surface 38, the top opening being dimensioned and configured for receiving various tools for providing the described functions. The carriage member 30 can also be provided with grips on an external surface of the flange 32 to aid in the operation of the carriage member 30 during use.

The bottle closure system further comprises a closure cutter assembly 70 that is attachable to the carriage member 30, via the top opening of the carriage member 30 in one embodiment, so that the cutter assembly 70 is movable with and located substantially within the internal cavity of the carriage member 30. The cutter assembly 70 comprises a cutting edge 72 mounted to a concentric rim 74. The cutting edge 72 extends in the direction of a seal of the first sealable opening 41 in use, and is located on an off-centre side of the concentric rim 74 so that relative rotation of the cutting edge about its axis would cause the cutting edge 72 to cut along a circular path. In one embodiment, the cutting edge 72 extends in the direction of the seal from a perimeter of the concentric rim 74. In the preferred embodiment, the cutting edge 72 is integrally formed with the concentric rim 74 and substantially conforms to a contour of the rim 74. It would be appreciated that the cutting edge 72 of the cutter assembly 70 is configured to operate within the diameter of the first sealable opening 41 so as to pierce and cut the seal in use. In some configurations, the concentric rim 74 has a diameter that is smaller than that of the first sealable opening 41 and non-limiting dimensional examples of the concentric rim 74 include diameter of about 25 to 35 millimetres. While the cutting edge 72 has been described to be mounted to a concentric rim 74, it is to be understood that other suitable cutter and cutting edge configurations may be used, such as a single downwardly extending cutter blade mounted off-centre relative to the first sealable opening 41.

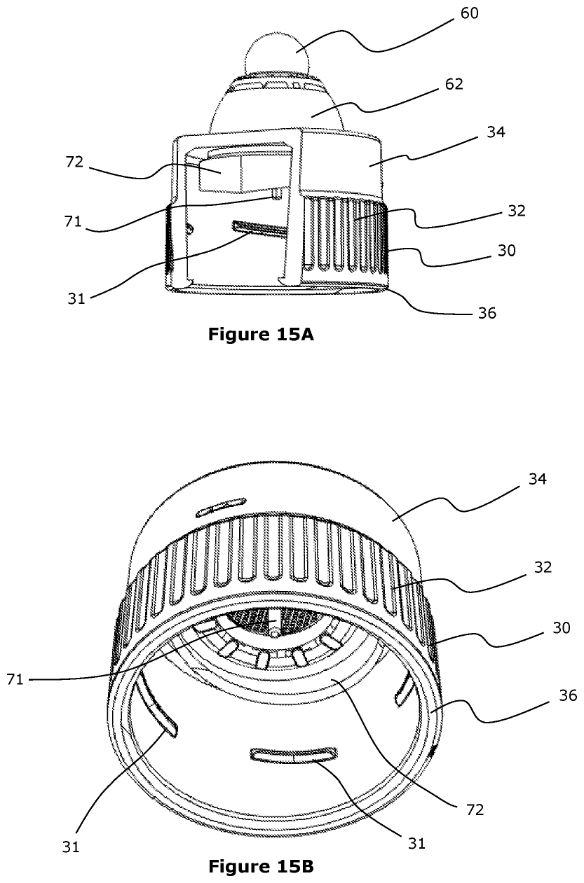

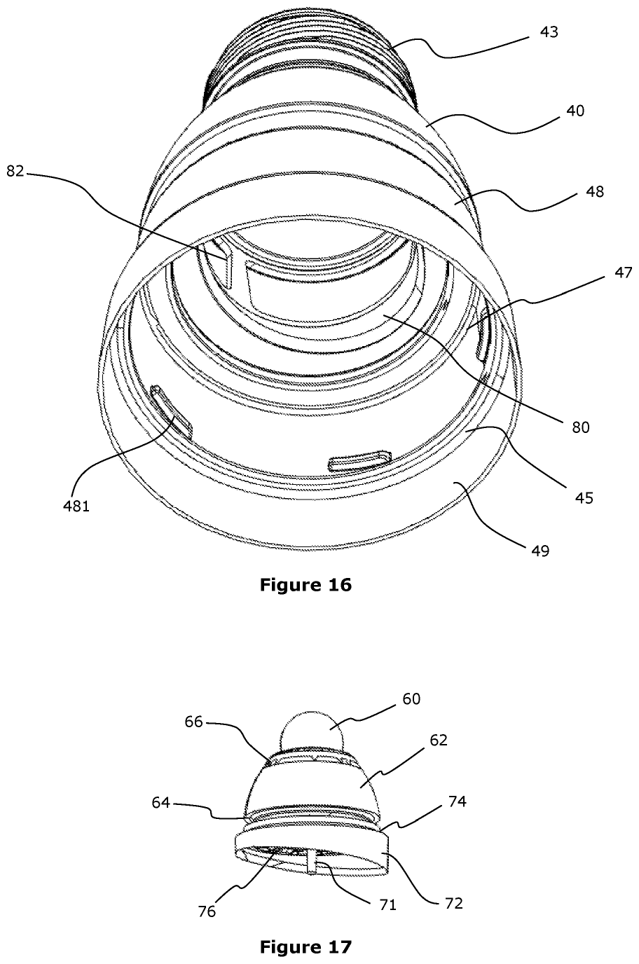

In the preferred embodiment, the cutter assembly 70 further comprises a filter 76 mounted to the concentric rim 74 for filtering contents to be dispensed from the first housing 40. The filter 76 could be made from any suitable material, such as a membrane filter. While in the preferred embodiment, the filter 76 is mounted to the cutter assembly 70, in other configurations, the filter 76 may be separately attachable or integrally formed with the cutter assembly 70, or separately attachable to the carriage member 30. The filter 76 is centrally located relative to the concentric rim 74 and comprises a raised annular wall having lip 78 that is dimensioned to be frictionally engageable with a teat 60 as seen in FIGS. 15 and 17. According to the preferred embodiment, the assembled form of cutter assembly 70, including the filter 76, and the teat 60 are arranged to be frictionally engageable with a rim of the top opening of the carriage member 30, thereby operatively mounting the assembled cutter assembly 70 and the teat 60 to the carriage member 30. It is to be understood that while a teat 60 has been described in relation to the drawings, it is also possible to use other dispenser tops such as nozzles or other suitable outlets. In an alternative embodiment, the cutter is separately mountable to the carriage member without having to first couple with a filter, teat or nozzle.

The cutter assembly 70 may also be provided with a guide member 71 for displacing the seal of the first sealable opening 41 after the seal is pierced and cut by the cutting edge 72. In one embodiment, the guide member 71 is in the form of a pin and the pin is configured to push the seal being pierced downwardly toward the direction of the first storage chamber. In one configuration, the pin is integrally formed with the filter 76, while in other embodiments, the pin is separately attachable to the cutter assembly or the carriage member 30.

Returning to FIG. 6, while the neck 43 of the first housing 40 is threadably engageable relative to the carriage member 30, it is additionally configured to be frictionally interengageable with the carriage member 30 so as to create two different engagement states, being an extended state and a retracted state. The extended state, the neck 43 and the carriage member 30 are so positioned to prevents the cutter assembly 70 mounted to the carriage member 30 from piercing the seal of the first sealable opening 41, while in the retracted state, the neck 43 and the carriage member 30 are so positioned so as to allow the cutter assembly 70 to pierce the seal of the first sealable opening 41 upon relative rotation of the carriage member 30 and the neck 43. The neck 43 and the carriage member 30 are moveable between the extended state and the retracted state by overcoming a frictional barrier by rotating the carriage member 30 relative to and toward the neck 43. A user would have to manually exert force, for example by way of threadingly rotating the carriage member 30 relative to the neck 43 or alternatively by force, to move the carriage member 30 toward the neck 43 of the first housing 40 in an axial, end to end, direction. In one embodiment, continued rotational coupling between the neck 43 and the carriage member 30 results in the retracted state, in which the seal is subsequently pierced and cut by the cutting edge 72 of the cutter assembly 70. This advantageously prevents the cutting 70 from prematurely piercing the seal and to ensure that opening of the seal of the first sealable opening 41 could only occur once the user has engaged the carriage member 30 and the neck 43 of the first housing 40 past the frictional barrier.

In the preferred embodiment, the frictional barrier is created by having a substantially annular rib 421 located on the neck 43. The annular rib 421 is configured to be frictionally engageable with a corresponding annular projection 36 of the carriage member 30. In one configuration, the projection 36 is internally located at a lip of the annular flange 32 of the carriage member 30. In one configuration, the annular rib 421 is located below the threadable portion of the neck 43 and the height of the carriage member 30 is arranged so that the threadable portions of the neck 43 and the flange 32 will not engage, or have minimal engagement, when the neck 43 and the carriage member 30 are in the extended state. It is to be appreciated that while the rib 421 and the projection 36 have been described to be annular in configuration, it is also possible to have only the rib 421 or only the projection 36 to be annular in configuration without departing from the spirit of the invention. It is also to be appreciated that there could be many variations in the location and configuration of the rib 421 and projection 36 to create the frictional barrier between the extended and retracted states.

In one embodiment, the neck 43 is provided with a further rib 422 located adjacent the annular rib 421 to inhibit rotational movement of the carriage member 30 relative to the neck 32 when the corresponding projection 36 of the flange 32 abuts the further rib 422 in the retracted state, thereby locking relative movement of the neck 43 and the flange 32 in the rotational direction of travel. While the rib 422 is annularly configured in the preferred embodiment, it is to be appreciated that rib 422 does not need to be annular in providing the function of stopping further rotational travel of the carriage member 30 relative to the neck 43. In one configuration, the further rib 422 is located about 6 to 10 millimetres below the rib 421.

Referring now to FIGS. 11A and 11B, the teat 60 is provided in the form of a foldable teat that is configured to be foldably stowable relative to a longitudinal body 62 of the teat 60. In particular, the teat 60 comprises a dispensing head and a length 66 of the teat 60 can be folded inwardly so as to reduce its storage length when not in use. In other configurations, a suitable teat 60, nozzle or outlet could be configured to be foldably bendable and/or rollable so as to be compactly stowed in the form of a curled-up elephant trunk to reduce footprint when not in use. In the preferred embodiment, the bottom rim of the teat 60 is configured to receive the lip 78 of the filter 76 and the teat 60 is provided with a groove dimensioned to be received by the top opening of the carriage member 30. In alternative embodiments, the teat 60 is directly attachable to the cutter assembly 70. While a teat 60 has been described, it will be appreciated that the invention is equally suitable for use with other dispensing mechanisms such as a nozzle or any other outlet forms.

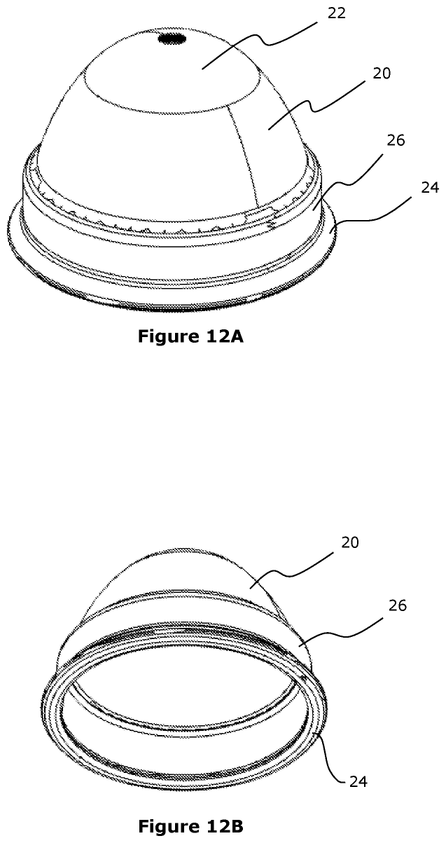

With reference to FIGS. 12A and 12B, a dome shaped cap 20 is provided to be mounted to an annular wall 34 of the carriage member 30 covering the teat 60 and cutter assembly 70 so as to keep the closure system clean when not in use. The cap 20 comprises a domed top 22, an annular wall 26 which is configured to frictionally engage the corresponding annular wall 34 of the carriage member 30, and a lip edge 24. The cap can be transparent or opaque and made from any suitable material.

The bottle system 10 and the bottle closure system as described above may be provided to users in the form of a kit of parts or separately provided in an assembled state. In the kit of parts, all of the component described above may be provided separately for assembly, while in the assembled state, the first and second housings 40, 50 are provided with content and suitably sealed and the carriage member 30 is provided with the assembled teat 60, cutter assembly 70, including the filter 76 and the guide member 71, and cap 20. The bottle and closure systems 10 may be manufactured from any suitable material, and preferably from materials that are recyclable. The neck 43 of the first housing is preferably made from a flexible material to assist with the frictional engagement of the carriage member 30 and the neck 43 past the rib 421.

In use, the carriage member 30 is initially either separated or coupled to the neck 43 of the first housing 40 in the extended state. When the user has completed mixing the contents of the first and second housings 40, 50 as described above, or if the content is already ready for consumption (for example, in a bottle with only a single housing), then the user either pushes or rotates the carriage member 30 downwards relative to the neck 43 of the first housing 40 in an axial direction to overcome the frictional barrier until a “click” sound is heard. This feature advantageously prevents premature opening of seals until such time that the contents of the bottle are ready to be consumed. Once the frictional barrier is overcome, the carriage member 30 and the first housing 40 are deemed to be in the retracted state. In the retracted state, and the carriage member 30 and the neck 43 are rotatably actuated by the user and the cutting edge 72 progressively pierces and cuts the seal sealing the sealable opening 41 in a circular path. While the seal is being cut, the guide member 71 of the carriage member 30 pushes the seal downwards to keep the cut seal open. The user would rotate the carriage member 30 relative to the neck 43 until the projection 36 of the carriage member 30 abuts the further rib 422 of the neck 43, thereby locking the carriage member 30 to the neck 43 and restricting further movement in the direction of rotation. In this state, the contents of the bottle system is ready to be dispensed by removal of the cap to access the teat 60 or nozzle therein. Although the steps described above is provided in a specific order, it is to be understood that they can be performed in any variation of this order and additional steps may be executed between the steps described.

Although the bottle system and the bottle closure system have been described to be used together, it is to be understood that it will be equally suitable for the bottle system and the bottle closure system to be used with conventional bottles or closures without departing from the spirit of the invention. Other components of the system as described herein may also be suitable for use with conventional bottles or closures independent from the systems as described.

In this specification, it is to be understood that the word “substantially” is used merely to indicate an intention that the term it qualifies should not be read too literally and that the word could mean “nearly enough for the patentee's purposes”.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

What is claimed is:

1. A bottle system, comprising:
a first housing having a proximal end, at which a first sealable opening is located, and an opposing distal end, between which a second sealable opening is located, wherein a first storage chamber is defined between the first and second sealable openings of the first housing;
a second housing having a second storage chamber defined between a third sealable opening and a base, wherein the first housing and the second housing are adapted to be rotatably coupled relative to each other in an end-to-end configuration between at least a first state, in which the first and second storage chambers are separated from each other, and a second state, in which the first and second storage chambers are coterminous; and
a cutter mounted within either the first storage chamber or the second storage chamber such that, in use, the cutter pierces seals of the second and third sealable openings, thereby combining contents of the first and second storage chambers, as the first and the second housings are rotatably actuated from the first state to the second state.

2. A bottle system according to claim 1, wherein the first housing comprises an overmoulded skirt configured to rotatably engage with a threaded portion of the second housing.

3. A bottle system according to claim 2, wherein the overmoulded skirt is located at or about the distal end of the first housing.

4. A bottle system according to claim 1, wherein the overmoulded skirt partially overlaps an external surface of the second housing.

5. A bottle system according to claim 1, wherein the second housing comprises an overmoulded skirt configured to rotatably engage with a threaded portion of the first housing.

6. A bottle system according to claim 1, wherein the first housing comprises a first annular shoulder located at or adjacent the second sealable opening and the second housing comprises a second annular shoulder located at or adjacent the third sealable opening, and wherein the first and the second shoulders are arranged to abut each other when the first and second housings are rotatably coupled in a third state, in which the housings are restrained from further rotation relative to each other in the direction of relative rotation.

7. A bottle system according to claim 1, wherein the cutter comprises a cutting edge oriented in the direction of the seal such that relative rotation of the first and second housings from the first state to the second state causes the cutter to cut the seals along a circular path.

8. A bottle system according to claim 7, wherein the cutter comprises a concentric rim and the cutting edge extends from a perimeter of the concentric rim.

9. A bottle system according to claim 7, wherein the cutting edge is integrally formed with the concentric rim, and wherein the cutting edge conforms to a contour of the concentric rim.

10. A bottle system according to claim 8, wherein the concentric rim has a diameter that is smaller than that of the second or third sealable openings.

11. A bottle system according to claim 7, wherein the concentric rim has a diameter of about 30 to 40 millimetres.

12. A bottle system according to claim 7, wherein the cutter further comprises an annular frame, which is configured to be mountable within the first or second storage chamber to secure placement of the cutter.

13. A bottle system according to claim 12, wherein the cutting edge of the cutter is joined to the annular frame by one or more supporting struts.

14. A bottle system according to claim 7, wherein the cutting edge of the cutter is located adjacent the seal of the second sealable opening.

15. A bottle system according to claim 1, wherein in use, the first storage chamber is configured to store dry content and the second storage chamber is configured to store liquid content.

16. A bottle system according to claim 1, wherein in use, the first storage chamber is configured to store liquid content and the second storage chamber is configured to store dry content.

17. A bottle system according to claim 1, wherein the seals comprise aluminium or composite foil seals attached to a rim surface of the respective sealable opening.

18. A bottle system according to claim 1, further comprising a bottle closure mountable to the proximal end of the first housing.

19. A bottle system according to claim 18, wherein the bottle closure comprises a dispenser for dispensing content from the first sealable opening.

20. A bottle system according to claim 1, further comprising:
a carriage member mountable to a neck portion located adjacent the sealable opening of the first housing, the carriage member comprising an annular flange within which an internal cavity is defined; and
a cutter attachable to the carriage member such that the cutter is movable with, and located substantially within the internal cavity of, the carriage member, the cutter being configured to pierce a seal of the first sealable opening,
wherein the carriage member and the neck are configured to be frictionally interengageable in use between an extended state, whereby the cutter does not pierce the seal, and a retracted state, whereby the cutter is able to pierce the seal upon relative rotation of the carriage member and the neck.

21. A method of operating a bottle system according to claim 1, the method comprising rotatably coupling the first housing and the second housing in an end-to-end configuration from the first state to the second state such that the cutter pierces seals of the first storage chamber and the second storage chamber to combine contents stored therein.

22. A method according to claim 21, wherein the combined contents are mixed by agitation of the bottle system, when the first and second housings are in a coupled state, and dispensed through the first sealable opening of the first housing.

23. A kit of parts for a bottle system comprising a first housing, a second housing, and a cutter mountable within either a first storage chamber or a second storage chamber, according to claim 1.

24-51. (canceled)
